(19) United States
(12) Patent Application Publication
(10) Pub. No.: US 2022/0299114 A1
(43) Pub. Date: Sep. 22, 2022

(54) LEATHER FLANGE FOR A BIDIRECTIONAL SEAL ASSEMBLY

(71) Applicant: Amsted Rail Company, Inc., Chicago, IL (US)

(72) Inventors: Linas Maskaliunas, Vancouver, WA (US); Samant Khanna, Vancouver, WA (US)

(21) Appl. No.: 17/701,363

(22) Filed: Mar. 22, 2022

Related U.S. Application Data
(60) Provisional application No. 63/164,195, filed on Mar. 22, 2021.

(51) Int. Cl. F16J 15/3228; F16J 15/3212

(52) U.S. Cl. CPC F16J 15/3228; F16J 15/3212

(57) ABSTRACT

A leather flange for a bidirectional seal assembly includes a radial flange leg encircling a rotation axis of the leather flange. The leather flange also includes an oblique flange leg encircling the rotation axis and joined to the radial flange leg. The oblique flange leg extends both radially inward and axially away from the radial flange leg to form an oblique angle with the rotation axis. An end face of the oblique flange leg forms a sinusoidal pattern around a circumference of the leather flange. The end face also meets an air-side surface of the oblique flange leg to form a lip. When the leather flange is installed around a shaft, the lip forms a sinusoidal path around the circumference of the shaft. As the shaft rotates, the sinusoidal path of the lip creates an axial back-and-forth sweeping action.

### RELATED APPLICATIONS

This application claims priority to U.S. Provisional Patent Application No. 63/164,195, filed on Mar. 22, 2021, the entirety of which is incorporated herein by reference.

### BACKGROUND

A seal assembly is used as part of the lubrication system around a rotating shaft. The seal assembly includes a lip that provides a dam to prevent lubricant from draining away from an oil side of the seal assembly, and that also provides a mechanism for maintaining a thin film of lubricant between the lip and the rotating shaft.

A seal assembly provides a pumping mechanism to minimize or prevent leakage of lubricant from the oil side to the air side of the seal. The pumping mechanism occurs when interaction between the lip of the seal assembly and a rotating shaft causes lubricant to be pumped back to the oil side. Several geometric features of the seal assembly may influence its pumping performance. Two of these are the angles between the surface of the rotating shaft and the surfaces of the lip on the air and oil sides. Other features may include dimensions such as beam length and thickness of portions of the seal.

The pumping mechanism is generally understood to develop through an interaction between the lip and the rotating shaft over time, for example, by the formation of microasperities in the wear track of a radial lip seal. These microasperities are formed and functional while the shaft continues to rotate in the same direction. However, if the direction of rotation of the shaft is changed, such as when a forward-moving vehicle is changed into reverse, the seal assembly loses much of its effectiveness.

### SUMMARY

In embodiments, a leather flange for a bidirectional seal assembly includes a radial flange leg encircling a rotation axis of the leather flange. The leather flange also includes an oblique flange leg encircling the rotation axis and joined to the radial flange leg. The oblique flange leg extends both radially inward and axially away from the radial flange leg to form an oblique angle with the rotation axis. An end face of the oblique flange leg forms a sinusoidal pattern around a circumference of the leather flange. The end face also meets an air-side surface of the oblique flange leg to form a lip. The leather flange may be fabricated from a single piece of leather.

When the leather flange is installed around a shaft, the lip forms a sinusoidal path around the circumference of the shaft. As the shaft rotates, the sinusoidal path of the lip creates an axial back-and-forth sweeping action that advantageously produces less friction and lowers operating temperatures, as compared to other types of lip seals.

### BRIEF DESCRIPTION OF THE FIGURES

FIG. 1 is a cross-sectional view of a bidirectional seal assembly with a leather flange, in embodiments.

FIG. 2A is a more detailed cross-sectional view of the leather flange of FIG. 1, in embodiments.

FIG. 2B is an isometric view of the leather flange of FIG. 1, in embodiments.

FIG. 3A is a side cross-sectional view of the leather flange of FIG. 1 through its axis, in embodiments.

FIG. 3B is a diagram of a sinusoidal wave pattern on an end face of the leather flange of FIG. 1, in embodiments.

FIG. 4 is a graph showing a sinusoidal path of the leather flange of FIG. 1, in embodiments.

FIG. 5 is a graph showing movement of the sinusoidal path of FIG. 4 over time, in embodiments.

FIG. 6 is an illustration showing principles of seal pumping in a radial lip seal.

FIG. 7 is a cross-sectional view of a bidirectional seal assembly used with a sleeve, in embodiments.

### DETAILED DESCRIPTION

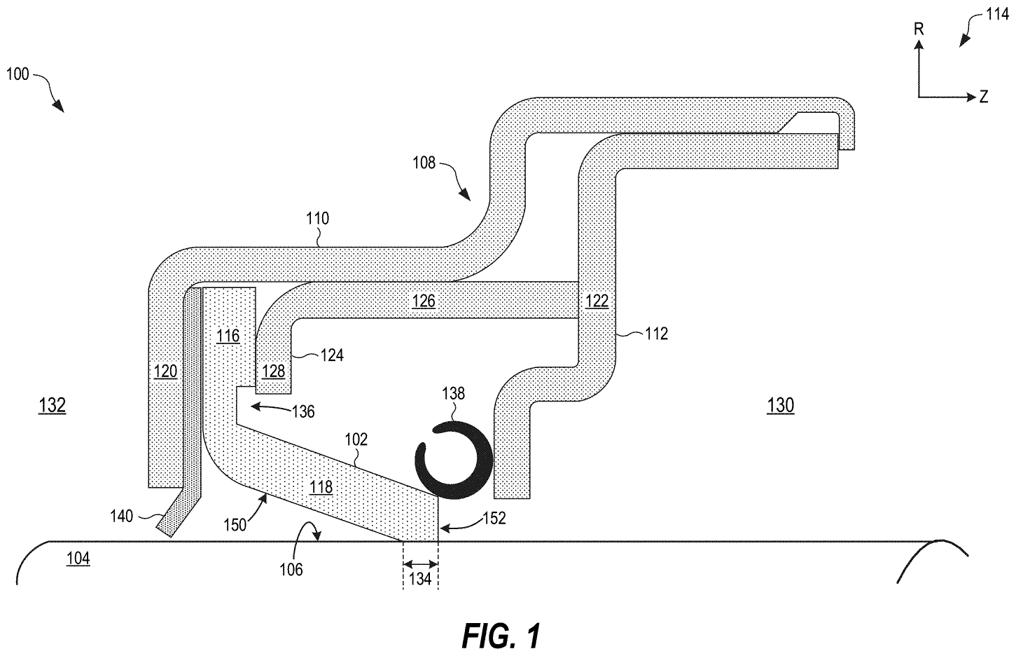

FIG. 1 is a cross-sectional view of a bidirectional seal assembly 100 with a leather flange 102. The bidirectional seal assembly 100 is a rotary lip seal for use with a rotating shaft 104 having a cylindrical surface 106. The bidirectional seal assembly 100 provides a seal between a lubricating fluid, such as oil, and an outside environment. Various aspects of the bidirectional seal assembly 100 may be described in terms of a fluid side 130 and an air side 132. The bidirectional seal assembly 100 includes a seal case 108 having an outer frame 110 and an inner frame 112. Dimensions and orientations are described herein in relation to a cylindrical coordinate system 114. The Z axis is parallel to the rotational axis of the shaft 104. The R axis is perpendicular to the Z axis and corresponds to a radial direction of the shaft 104.

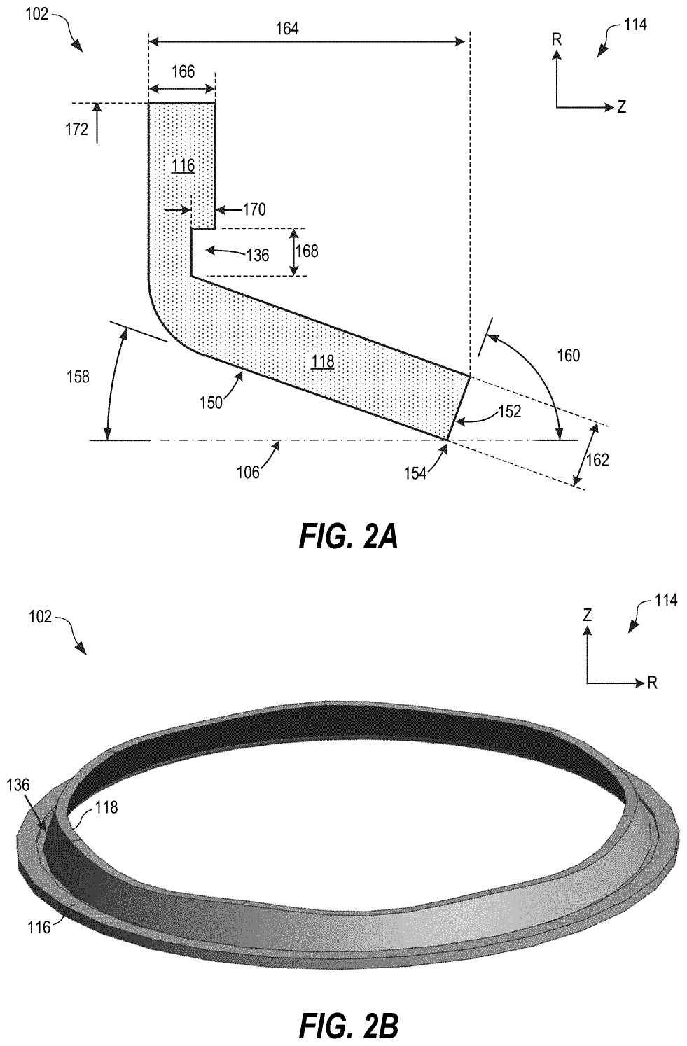

The leather flange 102 includes a radial flange leg 116 and an oblique flange leg 118. The oblique flange leg 118 forms a truncated conical shell (see FIG. 2B) around the rotating shaft 104. The leather flange 102 is not bonded to the seal case 108, but is retained between an inner radial section 120 of the outer frame 110 and a middle radial section 122 of the inner frame 112 through the use of a spacer 124. The spacer 124 includes an axial section 126 and a radial section 128. The radial flange leg 116 is retained between the inner radial section 120 and the radial section 128. In embodiments, an excluder lip 140 may also be retained between the inner radial section 120 and the radial flange leg 116. The excluder lip 140 extends radially towards the shaft 104 and is used to prevent contaminants in the air side 132 from reaching the fluid side 130. In embodiments, other types of excluder lips may be used, such as an axial excluder lip.

In embodiments, the leather flange 102 has an inner diameter that is smaller than the diameter of the cylindrical surface 106. The bidirectional seal assembly 100 is then stretched over the shaft 104 during installation. Flexibility of the leather flange 102 may be provided by a relief groove 136 which allows the oblique flange leg 118 to flex radially with respect to the radial flange leg 116. After installation, a force is generated between the leather flange 102 and the shaft 104 that creates a sealing region 134. Additional radial force may be provided by a garter spring 138. Garter springs in radial lip seals augment the sealing force between the lip (see the lip 154 in FIG. 2A) and the shaft 104. Furthermore, the garter spring 138 may also compensate for changes in the leather flange 102 due to elevated temperatures, exposure to lubricants, or both. Thus, the garter spring 138 provides a more uniform load.

FIG. 2A is a more detailed cross-sectional view of the leather flange 102 of FIG. 1. FIG. 2B is an isometric view of the leather flange 102. Although dimensions are described herein, these are not limiting and are for purposes of illustration only. The oblique flange leg 118 has an air-side surface 150 and an end face 152 that meet at a lip 154. The end face 152 has a width 162 of approximately 0.080 to 0.102 inches. The lip 154 defines the inner diameter of the leather flange 102 when installed on the shaft 104. The air-side surface 150 forms an air-side angle 158, relative to the cylindrical surface 106, of approximately 15 to 35 degrees. The end face 152 forms a fluid-side angle 160, relative to the cylindrical surface 106, of approximately 75 to 90 degrees.

The leather flange 102 may have an overall axial length 164 of approximately 0.396 to 0.415 inches. The radial flange leg 116 may have an axial width 166 of approximately 0.083 to 0.103 inches. The relief groove 136 may have a radial height 168 of approximately 0.062 inches and an axial depth 170 of approximately 0.032 inches, although other dimensions may be used to provide more or less flexibility of the oblique flange leg 118. The leather flange 102 may have an outer diameter 172 of approximately 5.684 to 5.709 inches. As noted above, dimensions are given for the purposes of illustration and may vary with the diameter of the shaft 104.

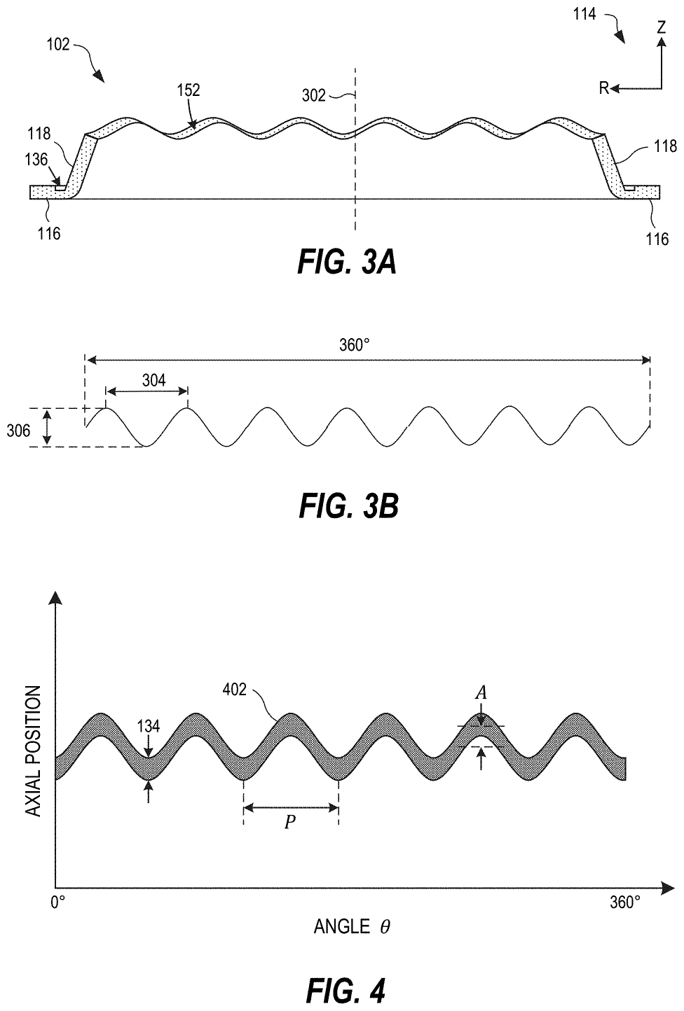

FIG. 3A is a side cross-sectional view of the leather flange 102 of FIGS. 2A and 2B through its axis 302. FIG. 3B is a diagram of a sinusoidal wave pattern on an end face of the leather flange 102. FIGS. 3A and 3B are best viewed together in the following discussion. The leather flange 102 is annular around the axis 302, which is coaxial with an axis of the shaft 104 (not shown). The end face 152 of the oblique flange leg 118 forms the sinusoidal wave pattern of FIG. 3B around its circumference. In embodiments, the sinusoidal wave pattern of FIG. 3B includes seven periods (see period 304 in FIG. 3 and period P in FIG. 4), each subtending approximately 51 degrees, although any number of periods may be used. The amplitude 306 of the sinusoidal wave pattern is approximately 0.010 inches.

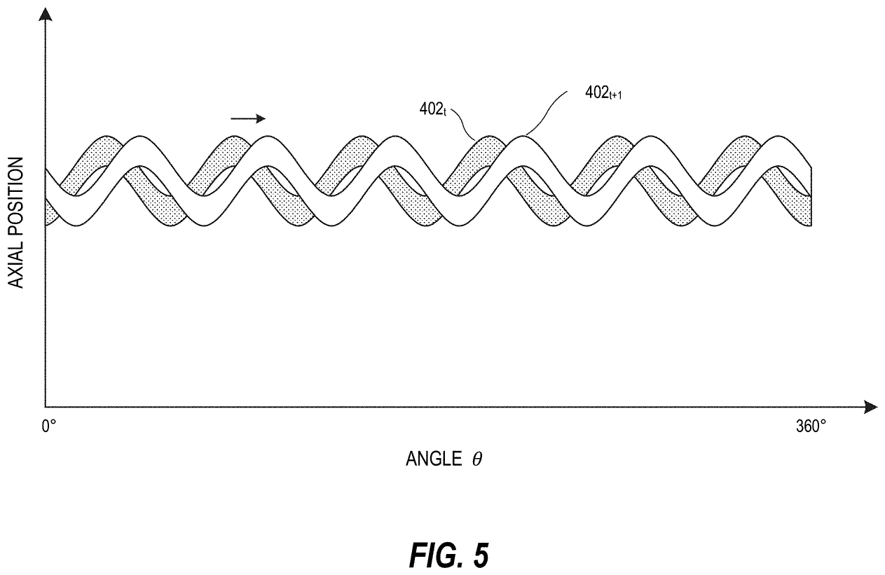

The sinusoidal wave pattern of FIG. 3B in the end face 152 comes into contact with the cylindrical surface 106 of the shaft 104 to create a sinusoidal path of the leather flange 102 across the shaft 104 in the sealing region 134, as illustrated in FIGS. 4 and 5. FIG. 4 shows that the sealing region 134 forms a sinusoidal path 402 around the circumference of the cylindrical surface 106 with an amplitude A and a period P. FIG. 5 shows that the sinusoidal path 402 moves, or ripples, across the shaft 104 between 402ₜ (at time t) and 402ₜ₊₁ (at a time t+1). This creates a sweeping action that advantageously produces less friction and lowers operating temperatures.

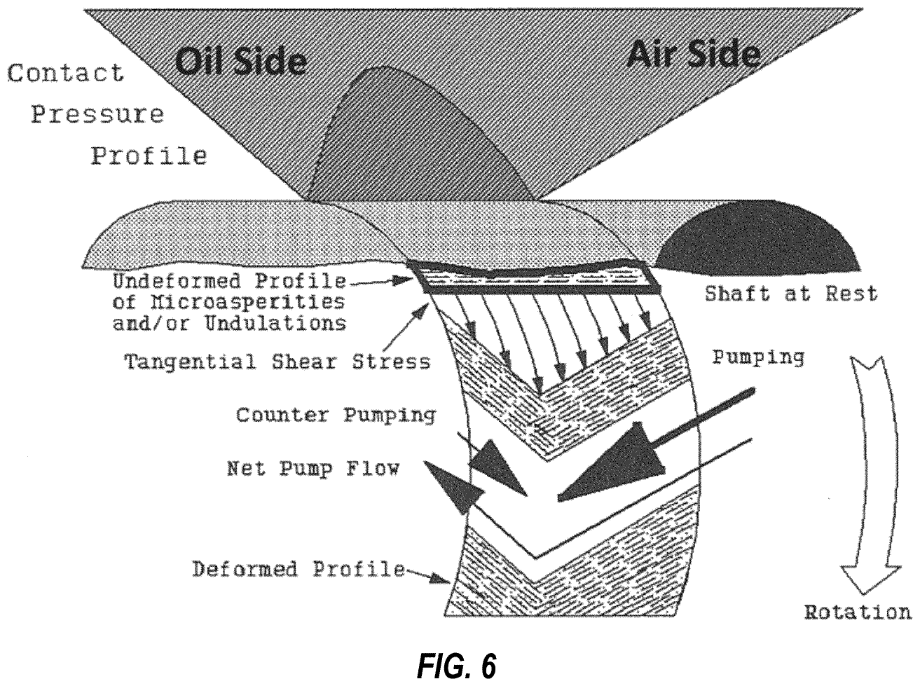

FIG. 6 is an illustration showing principles of seal pumping in a radial lip seal. The leather flange 102 forms microasperities that both draw lubricant into the sealing region 134 to lubricate the wear track in the cylindrical surface 106 of the shaft 104, and provide a pumping action that pushes lubricant back toward the fluid side 130.

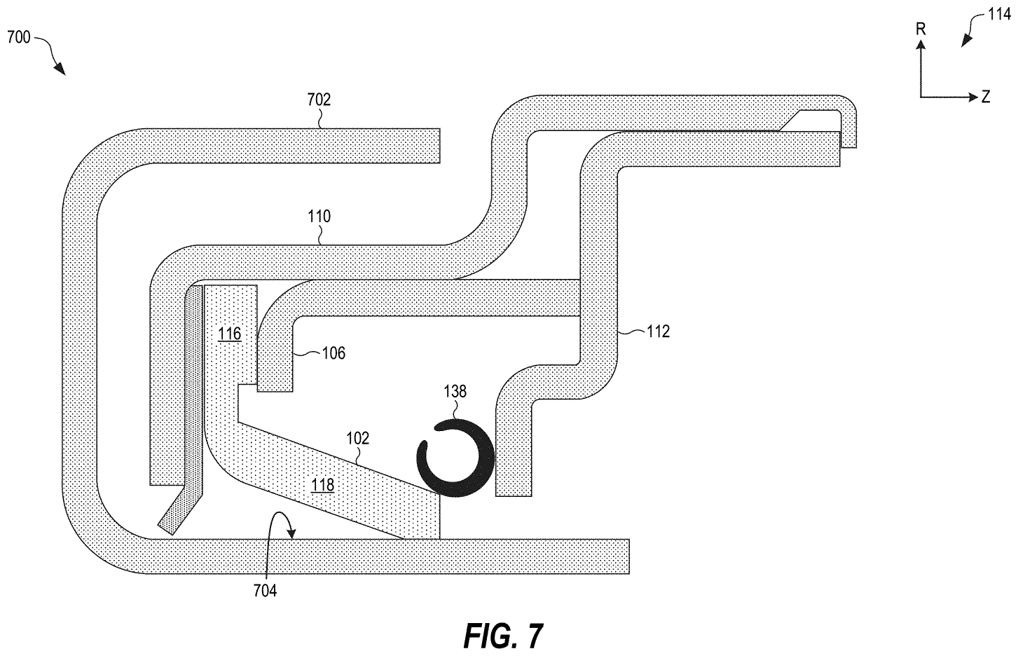

FIG. 7 is a cross-sectional view of a bidirectional seal assembly 700 used with a sleeve 702. The bidirectional seal assembly 700 is similar to the bidirectional seal assembly 100 of FIG. 1. Typically, a bidirectional seal assembly is designed with specifications that match and cooperate with those of the shaft 104 and other components of the system. In embodiments, a unitized seal may be provided with the sleeve 702 in situations where the shaft 104 is stationary and the seal assembly is rotating, for example. As shown in FIG. 7, the leather flange 102 forms a sealing region, or lip seal, with a radially outward-facing sleeve surface 704 of the sleeve 702.

Changes may be made in the above methods and systems without departing from the scope hereof. It should thus be noted that the matter contained in the above description or shown in the accompanying drawings should be interpreted as illustrative and not in a limiting sense. Herein, and unless otherwise indicated: (a) the adjective “exemplary” means serving as an example, instance, or illustration, and (b) the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

What is claimed is:

1. A leather flange for a bidirectional seal assembly, comprising:
a radial flange leg encircling a rotation axis of the leather flange; and
an oblique flange leg encircling the rotation axis and joined to the radial flange leg, the oblique flange leg extending both radially inward and axially away from the radial flange leg to form an oblique angle with the rotation axis;
wherein an end face of the oblique flange leg (i) forms a sinusoidal pattern around a circumference of the leather flange, and (ii) meets an air-side surface of the oblique flange leg to form a lip.

2. The leather flange of claim 1, the lip forming an air-side angle with respect to the rotation axis, the air-side angle being between 15 and 35 degrees.

3. The leather flange of claim 1, the lip forming an fluid-side angle with respect to the rotation axis, the fluid-side angle being between 75 and 90 degrees.

4. The leather flange of claim 1, the lip forming a sealing region that varies sinusoidally about the rotation axis.

5. The leather flange of claim 1, an axial position of the lip varying sinusoidally about the rotation axis.

6. The leather flange of claim 1, the sinusoidal pattern having an integer number of periods.

7. The leather flange of claim 6, the integer number of periods being between four and ten, inclusive.

8. The leather flange of claim 1, an amplitude of the sinusoidal pattern being between 0.002 inches and 0.020 inches, inclusive.

9. The leather flange of claim 1, the radial flange leg forming a relief groove where the radial flange leg meets the oblique flange leg.

10. The leather flange of claim 1, the oblique flange leg and the radial flange leg having a similar thickness.

11. A bidirectional seal assembly, comprising:
the leather flange of claim 1; and
a seal case encircling the rotation axis, the seal case having an inner frame, an outer frame, and a spacer between the inner frame and the outer frame, the spacer pushing the radial flange leg of the leather flange against the outer frame.

12. The bidirectional seal assembly of claim 11, further comprising a sleeve with a radially outward-facing sleeve surface, the lip of the leather flange contacting the radially outward-facing sleeve surface to form a sealing region.

13. The bidirectional seal assembly of claim 12, further comprising a garter spring encircling the oblique flange leg, the garter spring being axially positioned to radially compress the lip against the radially outward-facing sleeve surface.

14. The bidirectional seal assembly of claim 12, the lip forming an air-side angle with respect to the radially outward-facing sleeve surface, the air-side angle being between 15 and 35 degrees.

15. The bidirectional seal assembly of claim 12, the lip forming an fluid-side angle with respect to the radially outward-facing sleeve surface, the fluid-side angle being between 75 and 90 degrees.
